(19) United States
(12) Patent Application Publication
(10) Pub. No.: US 2012/0009054 A1
(43) Pub. Date: Jan. 12, 2012

(54) Railroad Freight Car Loading Or Unloading

(76) Inventors: David Kun, Federal Way, WA (US); George Chen, Los Gatos, CA (US)

(21) Appl. No.: 12/779,841

(22) Filed: Jul. 7, 2010

(51) Int. Cl. B61D 3/18; B61F 1/08; B60S 9/02; B61F 13/00; B60P 1/04; B60P 1/28

(52) U.S. Cl. 414/800; 280/47.131; 280/762; 105/211

(57) ABSTRACT

The present invention discloses an apparatus for transporting a container or semi-trailer including: a deck, the deck tilted at an angle; a dolly located below a rear section of the deck; a landing gear located below a mid-section of the deck; a jack located below a front section of the deck; a rail located below the dolly and the landing gear; and an external propulsion mechanism that is not a locomotive.

### CLAIM OF PRIORITY

This is a continuation-in-part application of U.S. patent application Ser. No. 12/777,278 filed on May 11, 2010 that is currently pending.

### BACKGROUND OF THE INVENTION

1. Field of the Invention

The present invention relates to a field of transportation, and, more specifically, to loading or unloading a railroad freight car.

2. Discussion of Related Art

A load being transported across a region may include freight (or lading). Freight of various sizes, shapes, and weights may be packed and combined in a container or semi-trailer with standard dimensions. The container or semi-trailer permits secure storage and reliable transportation.

Along a journey from one or more origination points to one or more destination points, the container or semi-trailer may be transferred among various modes of transportation. The various modes include by tractor on road, by railroad freight car (or rolling stock) on rail, by cargo ship on river, lake, or ocean, or by cargo airplane in air.

The present invention discloses a method of and an apparatus for loading or unloading a railroad freight car

### SUMMARY OF THE PRESENT INVENTION

Accordingly, an object of the present invention is to transfer a container or semi-trailer to or from an L-car.

Another object of the present invention is to change a tilt of a deck of an L-car having a landing gear.

Still another object of the present invention is to unfold or fold a landing gear of an L-car.

Yet another object of the present invention is to extend or retract a landing gear of an L-car.

A further object of the present invention is to move an L-car down a slope in order to load or unload a container or semi-trailer.

The foregoing and other objects of the present invention are achieved with a system of the present invention that may include a mechanism to operate a landing gear of an L-car.

The foregoing and other objects of the present invention may be further accomplished with an L-car of the present invention that may include a deck, a dolly attached to a rear section of the deck, a landing gear attached to a mid-section of the deck, and a jack attached to a forward section of the deck.

The system of the present invention will be more completely understood from the following detailed description of the present invention taken in conjunction with the drawings and the claims.

### BRIEF DESCRIPTION OF THE DRAWINGS

FIG. 1 shows a schematic elevation view of L-cars assembled in a string in a train according to an embodiment of the present invention.

FIG. 2 shows a schematic elevation view of a railway freight car with a dolly, a landing gear that folds backwards, and a jack according to an embodiment of the present invention.

FIG. 3 shows a schematic elevation view of a railway freight car with a dolly, a landing gear that folds forwards, and a jack according to an embodiment of the present invention.

FIG. 4 shows a schematic elevation view of a railway freight car with a dolly, a landing gear, and a deck with a hinge or joint near mid-section according to an embodiment of the present invention.

FIG. 5A shows an L-car dolly with a swiveling assembly and multiple wheels according to an embodiment of the present invention.

FIG. 5B shows an L-car landing gear having a mini-dolly with a swiveling assembly and multiple wheels according to an embodiment of the present invention.

FIG. 6A shows a bi-layer deck structure according to an embodiment of the present invention.

FIG. 6B shows a double-deck structure according to an embodiment of the present invention.

### DETAILED DESCRIPTION OF THE PRESENT INVENTION

In the following description, numerous details, examples, and embodiments are set forth to provide a thorough understanding of the present invention. However, it will become clear and apparent to one of ordinary skill in the art that the invention is not limited to the details, examples, and embodiments set forth and that the invention may be practiced without some of the particular details, examples, and embodiments that are described. In other instances, one of ordinary skill in the art will realize that certain details, examples, and embodiments that may be well known have not been specifically described so as to avoid obscuring the present invention.

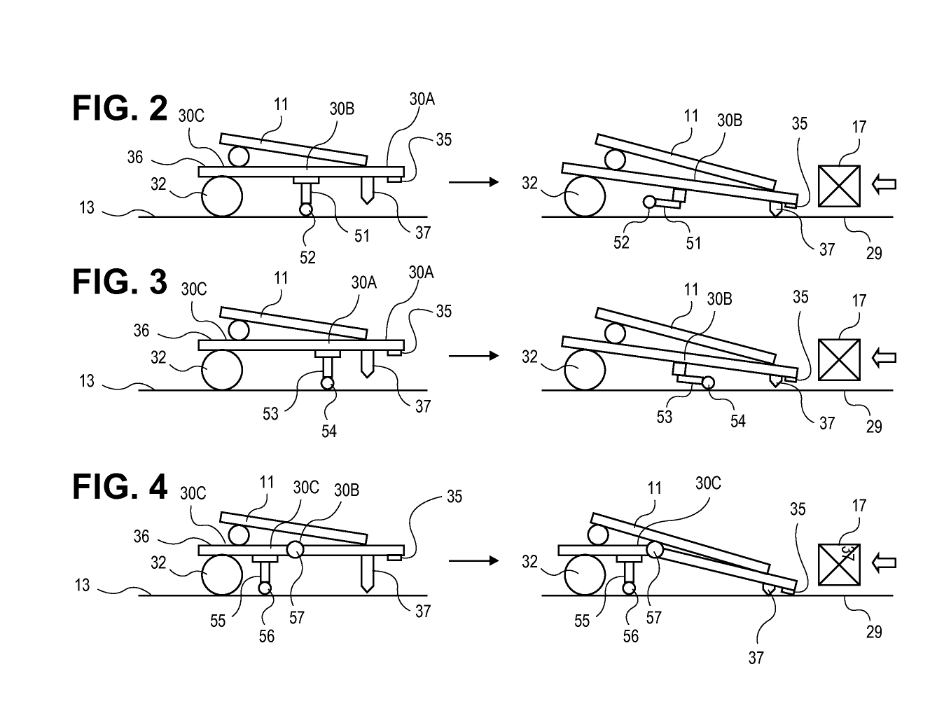

The present invention envisions an apparatus for and a method of loading or unloading freight from an L-car of the present invention as shown in FIGS. 2-4.

Freight (or lading) having various sizes, shapes, and weights may be combined and stored in a container or semi-trailer 11. In most cases, the container or the semi-trailer 11 includes dimensions that have been standardized by organizations such as the International Standards Association (ISO).

Typical lengths of the container may include 20, 40, 45, 48, and 53 feet. Typical widths of the container may include 8 and 8.5 feet. Typical heights of the container may include 4.25 (or half height), 8, 8.5, 9.5, and 10.5 feet. Depending on the type of freight being transported, typical weights of the container may be 40,000-75,000 pounds when fully loaded.

In some cases, the semi-trailer 11 may be short (called a pup), such as 24, 28.5 feet, or long, such as 40, 48, 50, 53 feet. Depending on the type of freight being transported, typical weights of the semi-trailers 11 may be 35,000-100,000 pounds when fully loaded.

The container or semi-trailer 11 may be transported by a mode of transportation, such as a cargo ship, an airplane, or a train. At certain transfer locations, the container or semi-trailer 11 may be moved over to an intermediate mode of transportation, such as an L-car 30 of the present invention. The L-car 30 rests and travels on rail 13. Subsequently, the container or semi-trailer 11 may be moved to yet another mode of transportation, such as being connected to and then pulled by a tractor 17 on a road 29 as shown in FIGS. 2-4.

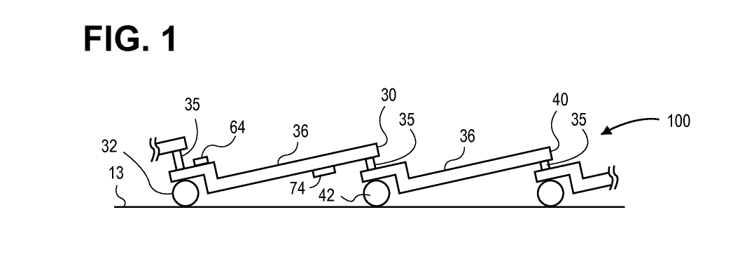

As shown in FIG. 1, the L-car 30 of the present invention may include a deck 36 that is tilted upwards (from rear to front) when assembled in a string in a train, a dolly (or truck or bogie) 32 attached below a rear section of the deck 36, and a fixture 35 attached below a front section of the deck 36 such that a container or semi-trailer 11 is loaded or unloaded from the front.

In another embodiment of the present invention, a reverse L-car (not shown) may include a dolly that may be attached below the front section of the deck and a fixture that may be attached below the rear section of he deck such that a container or semi-trailer 11 is loaded or unloaded from the rear. In one case, the deck of the reverse L-car may be tilted downwards (from rear to front) when assembled in a string in a train,

In some situations, an external propulsion mechanism may move, such as push or pull, the L-car 30 while not connected to a locomotive. In a first case, the L-car 30 may further include a rod or arm 64 to attach to an overhead external propulsion mechanism. In a second case, the L-car 30 may further include a cross-piece 74 to attach to an underlying external propulsion mechanism. Other structural members (not shown) with different geometries, shapes, sizes, dimensions, and attachment locations to the L-car 30 may connect the L-car 30 to the external propulsion mechanism.

The L-car 30 disclosed in the present invention may include a length selected from a range of 70-90 feet. In one case, a stretched version of the L-car may include a length selected from a range of 90-110 feet. In another case, a compact version of the L-car may include a length selected from a range of 50-70 feet.

In some embodiments, the L-car 30 may include other features, such as a midsection 30B that may be telescoping, flexible, articulated, jointed, hinged, rotatable, pivoting, or swiveling. An example is shown in FIG. 4. As needed, one or more of the features may be changed, modified, or customized, for the L-car 30 disclosed in the present invention. In one case, a telescoping version of the L-car may include an adjustable length selected from a range of 50-110 feet.

In a first case, the deck 36 of the L-car 30 may be tilted such that an upper surface of the deck 36 may be located a distance, or height, above a rail 13 from 0.5-2.0 feet. In a second case, the deck 36 of the L-car 30 may be tilted such that an upper surface of the deck 36 may be located a distance, or height, above a rail 13 from 1.0-2.5 feet. In a third case, the deck 36 of the L-car 30 may be tilted such that an upper surface of the deck 36 may be located a distance, or height, above a rail 13 from 1.5-3.0 feet. In a fourth case, the deck 36 of the L-car 30 may be tilted such that an upper surface of the deck 36 may be located a distance, or height, above a rail 13 from 2.0-3.5 feet. In a fifth case, the deck 36 of the L-car 30 may be tilted such that an upper surface of the deck 36 may be located a distance, or height, above a rail 13 from 2.5-4.0 feet. In a sixth case, the deck 36 of the L-car 30 may be tilted such that an upper surface of the deck 36 may be located a distance, or height, above a rail 13 from 3.0-4.5 feet. In a seventh case, the deck 36 of the L-car 30 may be tilted such that an upper surface of the deck 36 may be located a distance, or height, above a rail 13 from 3.5-5.0 feet.

In one case as shown in FIG. 6A, the L-car 30 may include a bi-layer deck structure. The bi-layer deck structure includes one deck with two discrete layers separated by a nominal spacing selected from a range of 0.3-1.0 foot. An upper layer 36B may be stacked over a lower layer 36A. The upper layer 36B and the lower layer 36A may be tilted separately to reduce the spacing to 0-0.3 foot. The upper layer 36B of the deck is adapted to move, slide, rotate, or pivot relative to the lower layer 36A of the deck. The upper layer 36B of the deck may hold freight, such as the container, on the chassis, or the semi-trailer 11 while the lower layer 36A of the deck may be structurally integrated with, and function with, an undercarriage or suspension of the L-car 30.

In another case as shown in FIG. 6B, the L-car 30 may include a double-deck structure. The double-deck structure includes two discrete decks separated by a vertical spacing selected from a range of 6-14 feet. An upper deck 38 is located above a lower deck 37. The upper layer 38 and the lower layer 37 may be tilted separately. The upper layer 38 and the lower layer 37 may be adjusted to reduce the vertical spacing to 0-6 feet. Freight may be held on both the upper deck 38 and the lower deck 37. The lower deck 37 may be structurally integrated with, and function with, the undercarriage of the L-car 30.

In one case, the L-car 30 may have a width selected from a range of 9-10 feet. In another case, the L-car 30 may have a width selected from a range of 10-11 feet.

In one case, the L-car 30 may include supported jointed or hinged outer side edges of the deck 36 that may fold (up or down) to reduce the width of the L-car 30 to 7 feet, such as to facilitate storage of the L-car 30 while unloaded.

In another case, the L-car 30 may include reinforced lateral extensions that may slide outwards sideways to increase the width of the L-car 30 to 13 feet, such as to facilitate loading or unloading of freight, such as from or to an adjacent dock, platform, or ramp. In one case, the reinforced lateral extensions of the deck 36 may slide inwards sideways to be stowed between the upper layer 36B and the lower layer 36A of the bi-layer deck structure shown in FIG. 6A.

As shown in FIG. 1, the L-car 30 may be assembled (with other L-cars) as part of a string 100 in a train such that the deck 36 of the L-car 30 may be tilted. The dolly 32 (near the rear) of the L-car 30 travels on rail 13 while the fixture 35 (near the front) of the L-car 30 mounts above the (rear) dolly 42 of another L-car 40 (located in front).

The deck 36 may include various configurations with different shapes, sizes, and tilts (relative to underlying rail 13). A portion of the deck 36 (over the rear dolly 32) may be horizontal (not shown) or tilted as shown in FIG. 1. Another portion of the deck 36 (forward of the rear dolly 32) may be straight as shown in FIGS. 2-6 or may drop down, such as in an L-shape as shown in FIG. 1. In one case, the deck 36 may have no bulkhead (at either a rear end or a front end) to facilitate loading and unloading. In another case, the deck 36 may include a bulkhead near one end, such as the rear end.

The L-car 30 may include a self-leveling mechanism (not shown), such as a gyroscopic device that may be computer-controlled, to monitor and, as desired, to maintain a constant tilt (whether negative, zero, or positive) of the deck 36 of the L-car 30 within a certain tolerance, regardless of whether the L-car 30 is in a stand-alone mode or is coupled in the string 100 in the train, located on a level surface (such as on a flat ground) or on a sloped surface, in motion or at rest, traveling straight or turning, and accelerating or decelerating. The self-leveling mechanism may operate in conjunction with the bi-layer deck structure shown in FIG. 6A.

In one embodiment of the present invention, the deck 36 of the L-car 30 (from rear to front) in the string 100 of L-cars may include an upward (positive-angled) tilt such that the deck 36 near the rear section 30C of the L-car 30 is lower than the deck 36 near the front section 30A of the L-car 30. The upward tilt may include +15 (+/−5) degrees. In one embodiment of the present invention, the deck 36 near the rear section 30C of the L-car 30 is located below a height of a top of the dolly 32, such as in an L-shape, while the deck 36 near the front section 30A of the L-car 30 is located above the height of the top of the dolly 32.

As an example, an upward tilt of +15 degrees may result in an upper surface of a 90-foot long deck 36 rising an additional 2 feet above a top of rail 13 while going from a rear (low) section 30C to a front (high) section 30A of the deck 36. More specifically, the deck 36 near the rear section 30C of the L-car 30 may be located 0.5-2.5 feet above a top of rail 13 while the deck 36 of the L-car 30 near the front section 30A of the L-car 30 may be 2.5-4.5 feet above the top of rail 13.

If desired, the landing gear of the container, on the chassis, or the semi-trailer 11 (being carried on the deck 36) may be retracted. Consequently, a downward tilt (from rear to front) of the container, on the chassis, or the semi-trailer 11 may compensate, in whole or in part, for the upward tilt (from rear to front) of the deck 36 of the L-car 30. The net result may be that the container, on the chassis, or the semi-trailer 11 may be approximately flat or level (and parallel) relative to the top of the rail 13 below the L-car 30. In most cases, the flat or level orientation for the container, on the chassis, or the semi-trailer 11 level will maintain greater stability for the container, on the chassis, or the semi-trailer 11, as well as, the internal contents (load), such as during acceleration or deceleration of the L-car 30. Stability will increase a margin of safety for the string 100 of the train while traveling on the rail 13.

In another embodiment of the present invention, the deck 36 of the L-car 30 (from the rear section 30C to the front section 30A) in the string 100 of L-cars may be approximately level (and parallel) relative to the top of the rail 13 below the L-car 30. The tilt of the level deck 36 may include 0 (+/−5) degrees.

In still another embodiment of the present invention, the deck 36 of the L-car 30 (from the rear section 30C to the front section 30A) in the string 100 of L-cars may include a downward (negative-angled) tilt such that the deck 36 near the rear section 30C of the L-car 30 is higher than the deck 36 near the front section 30A of the L-car 30. The downward tilt may include −15 (+/−5) degrees. In one embodiment of the present invention, the deck 36 near the rear section 30C of the L-car 30 is located above the height of a top of the dolly 32 while the deck 36 near the front section 30A of the L-car 30 is located below the height of the top of the dolly 32.

In one case, the dolly 32 does not extend outwards and past the rear section 30C of the deck 36 of the L-car 30 as shown in FIGS. 2-4. In another case, part of the dolly 32 may extend outwards and past the rear section 30C of the deck 36 of the L-car 30, as shown in FIG. 1, to increase horizontal and vertical clearance for a rear portion of the tilted deck 36 to drop below the height of the top of the dolly 32.

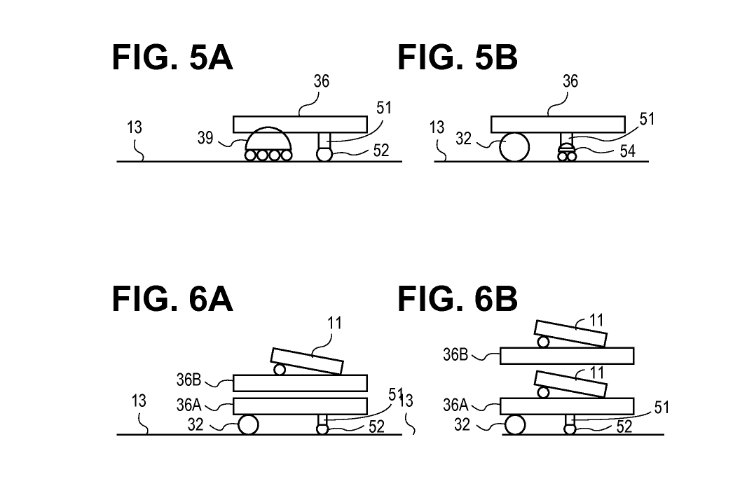

In one embodiment of the present invention as shown in FIG. 5A, the dolly 32 may include a swiveling assembly 39. In one case, the swiveling assembly 39 may include a dome-shaped joint with arrays of bearings, such as ball bearings or roller bearings. The dome-shaped joint may be enclosed in a removable housing, sealed from the external environment, continually lubricated, and temperature-controlled.

In a first embodiment of the present invention, the dolly 32 may be adapted to swivel horizontally, such as left or right, as much as +/−55 degrees on the rail 13, such as when negotiating a curve.

In a second embodiment of the present invention, the dolly 32 may be adapted to swivel vertically, such as up or down, as much as +/−25 degrees on the rail 13, such as when ascending or descending a slope, such as over a hill or into a valley.

In a third embodiment of the present invention, the dolly 32 includes a spring-loaded suspension mechanism, such as a bolster, (not shown) to maintain contact of the wheels (of the dolly) with the rail 13 whether the L-car 30 is in motion or at rest, and whether the deck 36 is tilted or level, such as horizontal.

In one case, the dolly 32 has no axle and is thus axle-less. In another case, the dolly 32 has only one axle (such as with oversized flanged wheels, such as having a diameter of 38 inches). In still another case, the dolly 32 may include multiple axles, such as 2-3 axles. In yet another case, the dolly 32 may include 4-5 axles. In a further case, the dolly 32 may include 6-7 axles.

In a first case, the dolly 32 of the L-car 30 includes flanged wheels with a diameter of 33 inches. In a second case, the dolly 32 of the L-car 30 includes oversized flanged wheels with a diameter of 38 inches. In a third case, the dolly 32 of the L-car 30 includes undersized flanged wheels.

A smaller diameter results in rotation of the flanged wheel at a higher number of revolutions per minute for a given lateral velocity or speed. A larger number of undersized flanged wheels may also be needed to handle a heavier load. However, the smaller flanged wheels permit the tilted deck 36 to drop lower and thus closer to the top of the rail 13.

I in one case, the dolly 32 of the L-car 30 may include undersized flanged wheels with a diameter of 28 inches. In another case, the dolly 32 of the L-car 30 may include undersized flanged wheels with a diameter of 23 inches. In still another case, the dolly 32 of the L-car 30 may include undersized flanged wheels with a diameter of 18 inches.

If desired, the dolly 32 may include flanged wheels that vary in diameter. The flanged wheels with different diameters may be optimized to accommodate certain situations, such as different loads (weight) or different speeds.

If desired, some of the flanged wheels on the dolly 32 may sometimes not be used (such as lifted off the rail 13) when the L-car 30 has a lighter weight, such as when empty (unloaded), or when traveling slower, such as when on a slope.

If desired, the dolly 32 may include flanged wheels that vary in spacing. In one case, the spacing between the flanged wheels may be adjustable.

The L-car 30 may include a fixture 35 attached near the front section 30A of the deck 36 of the L-car 30. As shown in FIG. 1, the fixture 35 near the front of the L-car 30 may be coupled or mounted above, or over, the dolly 42 near the rear of another L-car 40 located in front. In one case, the tilted decks of connected L-cars may include a zig-zag or saw-tooth appearance from the side.

When the L-car 30 is assembled in the string 100 in the train, the fixture 35 may be attached to a drawbar or tongue (not shown) that is in turn attached near the front section 30A of the L-car 30. The drawbar or tongue may swivel vertically (up or down) as much as +/−20 degrees depending on a combination of the tilt of the deck 36 and the slope of the ground (or other support, such as trestle) below the rail 13.

When the L-car 30 is assembled in the string 100 in the train, the fixture 35 may be coupled to a hitch (not shown) that is attached near the rear section 30C of the L-car 30 connected in front. The hitch may connect two consecutive L-cars together, such as in the string 100 in the train.

The hitch may include a load-balancing mechanism (not shown), such as with springs constrained under tension, to redistribute weight between the two L-cars when connected together. The hitch may swivel horizontally (left or right) as much as +/−40 degrees depending on curvature of the rails.

In one case, the fixture 35 at the front of the L-car 30 includes a coupler pin (or king pin) that fits into a collar at the rear of another L-car 40. In another case, the fixture 35 at the front of the L-car 30 includes a ball that fits into a bracket at the rear of another L-car 40. In still another case, the fixture at the front of the L-car 30 includes a ring that fits into a hook at the rear of another L-car 40.

It is important to consider a center of gravity (CG) of the L-car 30 when it is empty (unloaded) as well as when it is loaded, whether partially or completely. First, the lateral CG of the L-car 30 should be centered between the two rails. More importantly, the vertical CG of the L-car 30 should be centered relatively low, such as slightly above the centerline of the wheels of the dolly 32. Most importantly, the horizontal CG of the L-car 30 should be balanced at a position between the dolly 32 (towards the rear section 30C) and the hitch or tongue (towards the front section 30A) of the L-car 30.

A gross weight includes a net weight of the load combined with an empty (unloaded) weight of the L-car 30. On the one hand, locating the horizontal CG too far towards the rear section 30C of the L-car 30 will make the towed (rear) L-car 30 inherently unstable. On the other hand, locating the horizontal CG too far towards the front section 30A of the L-car 30 will make the towing (front) L-car inherently unstable.

Typically, better overall stability may be achieved by limiting a (front) hitch (or tongue) weight to about 10-45% of the gross (loaded) weight of the L-car 30. In most cases, the best overall stability may be accomplished by maintaining the hitch (or tongue) weight at about 15-30% of the total weight. Consequently, the horizontal CG of the L-car 30 may be located behind, or aft of, the midsection 30B of the L-car 30 and nearer the axles of the dolly in the rear section 30C of the L-car 30.

Consideration should also be given to other important factors, such as brake mechanism, gear train, drive mechanism, and locomotive pulling (or pushing) power over the rails. The effects on each individual L-car 30 going uphill or downhill should be carefully monitored, especially when the string 100 of L-cars 30 is short. The effects of the individual L-cars 30 negotiating a curve approaching a minimum radius should also be closely monitored.

In another case, the L-car 30 may include a landing gear attached to the deck 36 at a location near a mid-section 30B of the deck 36 between the dolly 32 and the fixture 35.

In one case as shown in FIG. 5B, the landing gear of the L-car 30 may include a leg 51 with a mini-dolly, such as with a swiveling assembly 59 that is adapted to swivel laterally and vertically. In one case, the swiveling assembly 59 may include a dome-shaped joint with arrays of bearings, such as ball bearings or roller bearings. The dome-shaped joint may be enclosed in a removable housing, sealed from the external environment, continually lubricated, and temperature-controlled.

In one case, the mini-dolly may have no axle and be axle-less. In another case, the mini-dolly may include 1 mini-axle. In still another case, the mini-dolly may multiple mini-axles, such as 2-3 mini-axles. In yet another case, the mini-dolly may include 4-5 mini-axles.

In one case, the mini-axles may include mini-wheels. In another case, the mini-dolly may include mini-wheels, such as casters, without any axle (or spindle). If desired, the mini-dolly may be detachable. If desired, the diameters and spacing of the wheels in the mini-dolly may be adjustable.

In another case, the landing gear of the L-car 30 may include axially-aligned, longitudinally telescoping, nested, segmented legs (not shown) that may be attached below the deck 36 of the L-car 30, such as with a bracket. The telescoping, nested, segmented legs may be moved with a hand crank mechanism or a motorized power winch assembly. The telescoping, nested, segmented legs may include a selectable bi-directional ratcheting device and an internal braking device. If desired, the telescoping, nested, segmented legs may include one or more counterweights to reduce an effort to move or position them.

The telescoping, nested, segmented legs may be positioned between or among various configurations to reversibly change a tilt of the deck 36 of the L-car 30. During deployment of the landing gear, such as when the L-car 30 may be free-standing, or parked, the legs may be lengthened by extending, or protruding, the nested segments outwards. In an embodiment of the present invention, the landing gear of the L-car 30 may include small wheels towards the ends of the legs that may rest on the rail 13. When storage of the landing gear is desired, such as when the L-car 30 may be in motion on the rail 13, the legs may be shortened by retracting, or recessing, the nested segments inwards. If desired, the telescoping, nested, segmented legs may be stored within a recessed cavity, such as with a hatch or cover.

In another case as shown in FIG. 2, the landing gear may include laterally bending legs 51 that may be attached below the deck 36 of the L-car 30, such as with a bracket. The legs 51 may be moved with a hand crank mechanism or a motorized power winch assembly. The legs 51 may pivot around a hinge, or joint, attached below the deck 36 of the L-car 30. The hinge, or joint, may include a selectable bi-directional ratcheting device and an internal braking device. If desired, the legs 51 may include one or more counterweights to reduce an effort to move or position them.

The legs 51 may be positioned between or among various configurations to reversibly change a tilt of the deck 36 of the L-car 30. In a deployed configuration, the legs 51 are unfolded forwards (until they are approximately vertical) so as to hold up, or support, the deck of the L-car 30. In a stored configuration, the legs 51 are folded backwards (until they are approximately horizontal) so as to lower the front section 30A of the L-car 30 (and tilt the deck 36 forwards) for unloading the container, such as on the chassis, or the semi-trailer 11. If desired, the legs 51 may be stored within a recessed cavity, such as with a hatch or cover.

The landing gear may further include cross-members and braces between the legs 51 to resist transverse as well as bending forces. In an embodiment of the present invention, the landing gear of the L-car 30 may include small wheels 52 towards the ends of the two legs 51. In one case, the wheels 52 are connected with an axle or spindle. In another case, the wheels 54 are not connected with an axle (or spindle) and are axle-less.

When detached from the string 100 and not mounted above, or over, the rear of another L-car in front, the L-car 30 deploys the landing gear on the rail 13 in order to provide support for a load, such as the container, on the chassis, or the semi-trailer 11 carried on the deck of the L-car 30. In one case, the landing gear of the free-standing, or parked, L-car 30 may handle a static load of 60-90 tons. In another case, the landing gear of the free-standing, or parked, L-car 30 may handle a static load of 90-120 tons. When the landing gear is deployed, the small wheels 52 towards the ends of the two legs 51 may rest on the rail 13.

In still another case as shown in FIG. 3, the landing gear may include laterally bending legs 53 that may be attached below the deck 36 of the L-car 30, such as with a bracket. The landing gear may further include cross-members and braces between the legs 53 to resist transverse as well as bending forces.

In an embodiment of the present invention, the landing gear of the L-car 30 may include small wheels 54 towards the ends of the two legs 53. In one case, the wheels 54 are connected with an axle or spindle. In another case, the wheels 54 are not connected with an axle (or spindle) and are axle-less.

The legs 53 may be moved with a hand crank mechanism or a motorized power winch assembly. The legs 53 may pivot around a hinge, or joint, attached below the deck 36 of the L-car 30. The hinge, or joint, may include a selectable bi-directional ratcheting device and an internal braking device. If desired, the legs 53 may include a counterweight to reduce an effort to move or position them.

The legs 53 may be positioned between or among various configurations to reversibly change a tilt of the deck 36 of the L-car 30. When detached from the string 100 and not mounted above, or over, the rear of another L-car in front, the L-car 30 deploys the landing gear on the rails in order to provide support for a load, such as the container, on the chassis, or the semi-trailer 11 carried on the deck 36 of the L-car 30.

In a deployed configuration, the legs 53 are unfolded backwards (until they are approximately vertical) so as to hold up, or support, the deck 36 of the L-car 30. In one case, the landing gear of the free-standing, or parked, L-car 30 may handle a static load of 60-90 tons. In another case, the landing gear of the free-standing, or parked, L-car 30 may handle a static load of 90-120 tons.

In a stored configuration, the legs 53 are folded forwards (until they are approximately horizontal) so as to lower the front section 30A of the L-car 30 (and tilt the deck 36 forward) for unloading the container, such as on the chassis, or the semi-trailer 11.

If desired, the legs 53 may be stored within a recessed cavity, such as with a hatch or cover. Alternatively, when the landing gear is stored, the small wheels 54 towards the ends of the two legs 53 may rest on the rail 13.

In another case as shown in FIG. 4, the landing gear may include legs 55 with wheels 56 to support a rear section 30C of the L-car 30. The legs 55 may be telescoping, bendable, or fixed. The legs 55 may be attached below the deck 36 of the L-car 30, such as with a bracket. If desired, the legs 55 may be stored within a recessed cavity, such as with a hatch or cover.

As shown in FIG. 4, the L-car 30 may further include a joint, or hinge, 57 attached at a mid-section 30B of the deck 36 to change between or among various configurations. As desired, the hinge, or joint, 57 may reversibly change a tilt of the deck 36 of the L-car 30. In a first configuration, the hinge 57 permits a forward section 30A of the deck 36 of the L-car 30 to pivot upwards until it becomes approximately level (horizontal) with an underlying rail 13. In a second configuration, the hinge 57 permits a forward section 30A of the deck 36 of the L-car 30 to pivot downwards until the front end of the L-car 30 is lowered (and the deck 36 is tilted forward) for unloading the container, such as on the chassis, or the semi-trailer 11.

In an embodiment of the present invention, the landing gear of the L-car 30 may include two legs 55 with small wheels 56. The landing gear may further include cross-members and braces between the legs 55 to resist transverse as well as bending forces. In one case, the wheels 56 are connected with an axle (or spindle). In another case, the wheels 56 are not connected with an axle (or spindle) and are axle-less.

When detached from the string 100 and not mounted above, or over, the rear of another L-car in front, the L-car 30 deploys the landing gear on the rail 13 in order to provide support for a load, such as the container, on the chassis, or the semi-trailer 11 carried on the deck 36 of the L-car 30. In one case, the landing gear of the free-standing, or parked, L-car 30 may handle a static load of 60-90 tons. In another case, the landing gear of the free-standing, or parked, L-car 30 may handle a static load of 90-120 tons. When the landing gear is deployed, the small wheels 56 towards the ends of the two legs 55 may rest on the rail 13.

In one case, the L-car 30 further includes a jack 37 that is attached near the front section 30A of the L-car 30. The jack 37 may be located slightly aft (behind) the fixture 35. The jack 37 may include a base plate that is broad. The base plate is self-leveling, such as by pivoting or swivelling, and may rest on uneven ground or on the rail 13. In one case, the jack 37 may include two or more vertical members with integrated cross-braces. In one case, the jack 37 spans a width equivalent to 40-80% of the width of the deck 36 of the L-car 30. In another case, the jack 37 spans a width equivalent to 80-120% of the width of the deck 36 of the L-car 30.

Externally, the jack 37 may include a manual crank mechanism or a motorized power winch assembly. Internally, the jack 37 may include a screw mechanism, a locking mechanism, and a release mechanism. For example, the jack 37 may include a selectable bi-directional ratcheting device and an internal braking device. If desired, the jack 37 may include one or more counterweights to reduce an effort to move or position it.

As desired, the jack 37 may shift between or among various configurations to reversibly change a tilt of the deck 36 of the L-car 30. In particular, as shown in FIGS. 2-4, the jack 37 may raise or lower the front section 30A of the deck 36 of the L-car 30.

In one embodiment, the jack 37 operates independently of the landing gear that may support the L-car 30. For example, the jack 37 may be deployed before adjusting or detaching the landing gear. Alternatively, the landing gear may be deployed before adjusting or detaching the jack 37.

In another embodiment, the jack 37 operates in conjunction with the landing gear that may support the L-car 30. For example, the jack 37 may be deployed before retracting or folding the landing gear. Alternatively, the jack 37 may be deployed before extending or unfolding the landing gear.

In another embodiment of the present invention, the L-car 30 may include an articulated deck 36 with two or more joints, or hinges, attached at various portions of the deck to change between or among various configurations. As desired, the multiple joints or hinges may reversibly change a tilt of the deck 36 of the L-car 30. In a first configuration, the multiple joints or hinges are pivoted upwards (until a forward section 30A of the deck of the L-car 30 becomes approximately horizontal). In a second configuration, the multiple joints or hinges are pivoted downwards so as to lower the front section 30A of the deck 36 of the L-car 30 (and tilt the deck 36 forward) for unloading the container, such as on the chassis, or the semi-trailer 11.

In still another embodiment of the present invention, the L-car 30 may lack a deck and, instead, may include a spine (not shown) to significantly reduce the unloaded (empty) weight of the L-car 30. The spine is reinforced with cross-members and braces. Two separate and parallel plates may be attached over the spine to support the wheels of the chassis (holding the container) or the semi-trailer 11. The plates may include lowered structures, such as channels, or raised structures, such as railings, to guide the wheels of the chassis (holding the container) or the semi-trailer 11. In one case, the spine may be articulated, jointed, hinged or telescoping so the length of the L-car 30 may be adjustable.

A landing gear and a jack 37 may be attached below the spine to change between or among various configurations. The landing gear may include legs with mini-dollies or mini-wheels. The legs may be telescoping, bendable, or fixed. The legs may be attached below the spine of the L-car 30, such as with a bracket. If desired, the legs may be stored within a recessed cavity, such as with a hatch or cover. As desired, the landing gear and the jack 37 may reversibly change a tilt of the spine of the L-car 30. In a first configuration, the spine is moved upwards (until a forward section 30A of the spine of the L-car 30 becomes approximately horizontal). In a second configuration, the spine is moved downwards so as to lower the front section 30A of the L-car 30 (and tilt the spine forward) for unloading the container, such as on the chassis, or the semi-trailer 11.

When desired, a tractor 17 may back up directly on an adjacent road 29. After tilting the deck of the L-car 30 forwards and downwards by 10-30 degrees, the tractor 17 connects to the container, such as on the chassis, or the semi-trailer 11 with the same hitch (not shown) that may connect two L-cars 30. Then, the tractor 17 may pull, the unloaded container, such as on the chassis, or the semi-trailer 11 off the free-standing, or parked, L-car 30. Subsequently, the tractor-trailer (a combination of the tractor 17 and the unloaded container, such as on the chassis, or the semi-trailer 11) may continue its journey on the road 29.

Many embodiments and numerous details have been set forth above in order to provide a thorough understanding of the present invention. One skilled in the art will appreciate that many of the features in one embodiment are equally applicable to other embodiments. One skilled in the art will also appreciate an ability to make various equivalent substitutions for those specific materials, processes, dimensions, concentrations, etc. described herein. It is to be understood that the detailed description of the present invention should be taken as illustrative and not limiting, wherein the scope of the present invention should be determined by the claims that follow.

We claim:

1. An apparatus for transporting a container or semi-trailer comprising:
a deck, said deck tilted at an angle;
a dolly disposed below a rear section of said deck;
a landing gear disposed below a mid-section of said deck; and
a jack disposed below a front section of said deck;

2. The apparatus of claim 1 further comprising an external propulsion mechanism that is not a locomotive.

3. The apparatus of claim 2 further comprising an arm disposed above said deck to attach to said external propulsion mechanism.

4. The apparatus of claim 2 further comprising a cross-piece disposed below said deck to attach to said external propulsion mechanism.

5. The apparatus of claim 1 further comprising a hinge disposed in said deck.

6. The apparatus of claim 1 wherein said deck comprises a bi-layer deck structure.

7. The apparatus of claim 1 wherein said deck comprises a double-deck structure.

8. The apparatus of claim 1 further comprising a swiveling mechanism disposed below said deck.

9. The apparatus of claim 1 wherein said dolly is axle-less and comprises oversized flanged wheels having a diameter of 38 inches.

10. The apparatus of claim 1 wherein said dolly comprises multiple axles with undersized flanged wheels having a diameter of 18 inches.

11. An L-car comprising:
a deck to carry a container or semi-trailer, said deck being tilted;
a dolly disposed below a rear section of said deck;
a swiveling mechanism disposed on said dolly, said swiveling mechanism adapted to swivel horizontally and vertically;
a landing gear disposed below a mid-section of said deck; and
a jack disposed below a front section of said deck.

12. The L-car of claim 11 wherein said landing gear comprises axially telescoping legs.

13. The L-car of claim 11 wherein said landing gear comprises laterally bending legs.

14. The L-car of claim 11 wherein said landing gear comprises wheels.

15. The L-car of claim 11 further comprising a mini-dolly disposed on said landing gear

16. The L-car of claim 11 further comprising a hinge disposed at a mid-section of said deck.

17. A method of transferring a container or semi-trailer comprising:
loading said container or semi-trailer onto a deck of an L-car;
moving said L-car on a rail without a locomotive;
tilting said deck of said L-car forward, said tilting being reversible; and
unloading said container or semi-trailer from said deck of said L-car.

18. The method of claim 17 wherein said moving said L-car comprises attaching said L-car to an external propulsion system.

19. The method of claim 17 wherein said tilting comprises bending legs of a landing gear of said L-car.

20. The method of claim 17 wherein said tilting comprises retracting a jack of said L-car.
